(19) United States
(12) Patent Application Publication
(10) Pub. No.: US 2017/0294143 A1
(43) Pub. Date: Oct. 12, 2017

(54) TRAINER FOR A MEDICAL PROCEDURE

(71) Applicant: Boston Scientific Scimed, Inc., Maple Grove, MN (US)

(72) Inventors: Jerry T. Long, JR., Jamaica Plain, MA (US); Jozef SLANDA, Milford, MA (US); Manuel B. TEIXEIRA, Boston, MA (US)

(73) Assignee: Boston Scientific Scimed, Inc., Maple Grove, MN (US)

(21) Appl. No.: 15/484,866

(22) Filed: Apr. 11, 2017

Related U.S. Application Data
(60) Provisional application No. 62/321,267, filed on Apr. 12, 2016.

(51) Int. Cl. G09B 23/28

(52) U.S. Cl. CPC G09B 23/28

(57) ABSTRACT

A trainer for medical procedures may include outer walls arranged to define an interior space; and inner walls arranged within the interior space to separate the interior space into a plurality of chambers; wherein at least some of the inner walls include at least one opening connecting adjacent chambers of the plurality of chambers.

### CROSS-REFERENCE TO RELATED APPLICATION

This application claims the benefit of priority under 35 U.S.C. §119 to U.S. Provisional Patent Application No. 62/321,267, filed Apr. 12, 2016, the entirety of which is incorporated herein by reference.

### TECHNICAL FIELD

Examples of the present disclosure relate generally to trainers for medical procedures. More specifically, the present disclosure relates to trainers for learning skills to control an elongated medical device, such as a ureteroscope.

### BACKGROUND

During urological procedures, surgeons must often navigate tortuous anatomy, strictures, and impacted stones using a medical device, such as a ureteroscope. Certain skills related to controlling the medical device may be useful during the procedure, such as gross and fine torque techniques and active and passive deflection. Many surgeons learn and practice these skills in the operating room.

### SUMMARY

Examples of the present disclosure relate to, among other things, trainers for medical procedures. Each of the examples disclosed herein may include one or more of the features described in connection with any of the other disclosed examples.

In one example, a trainer for medical procedures may include outer walls arranged to define an interior space; and inner walls arranged within the interior space to separate the interior space into a plurality of chambers; wherein at least some of the inner walls include at least one opening connecting adjacent chambers of the plurality of chambers.

The trainer may additionally or alternatively include one or more of the following features: at least some of the inner walls may include a plurality of openings; at least one of the outer walls may include a plurality of openings; each of the plurality of openings in the outer wall may lead to a different chamber of the plurality of chambers, and each of the different chambers may be connected to an adjacent different chamber by openings through the inner walls; at least one of the inner walls may be straight and at least one of the inner walls may be curved; the trainer may be configured to receive an elongate member of a medical device through an opening in at least one of the outer walls and through openings in the at least some of the inner walls; and a chamber of the plurality of chambers may be bounded by only three inner walls, and each of the three inner walls may include at least one opening.

In another example, a trainer for medical procedures may include outer walls arranged to define an interior space; and a plurality of chambers within the interior space and separated from each other by inner walls; wherein at least some of the inner walls include a plurality of discrete openings; and wherein at least one inner wall is straight and at least one inner wall is curved.

The trainer may additionally or alternatively include one or more of the following features: at least one of the outer walls may include a plurality of openings; each opening of the at least one outer wall may connect an exterior of the trainer to a different chamber of the plurality of chambers, and inner walls may separate adjacent chambers of the different chambers; at least one chamber of the plurality of chambers may be bounded by inner walls that include a zig-zag pattern; at least one inner wall may include a curved wall that forms a plurality of outward protrusions and a plurality of inward protrusions; and the trainer may further include a cover, wherein the cover may be movable between and open position and a closed position.

In yet another example, a method of using a trainer may include inserting a distal end of an elongate member of a medical device into an interior space of the trainer, the trainer including outer walls arranged to define the interior space, and inner walls arranged within the interior space to separate the interior space into chambers; and navigating the distal end through at least some of the chambers, wherein the navigating step includes passing the distal end through openings in at least some of the inner walls.

The method may additionally or alternatively include one or more of the following features or steps: the inserting step may include passing the distal end through one of a plurality of openings in one of the outer walls; the navigating step may include passing the distal end along a pre-selected pathway within the interior space; the navigating step may include active deflection of the distal end and passive deflection of the distal end; the navigating step may include passing the distal end through one of a plurality of openings in an inner wall, wherein the plurality of openings are arranged proximate to each other; the navigating step may include following a selected pathway with a cover open, and the method may further include repeating the navigating step with the cover closed; and at least one inner wall having an opening may be straight and at least one inner wall having an opening may be curved.

It may be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate examples of the present disclosure and together with the description, serve to explain the principles of the disclosure.

FIG. 1 is a side perspective view of a trainer, according to one example.

FIG. 2 is a front perspective view of the trainer of FIG. 1 with a ureteroscope being used with the trainer, according to one example.

### DETAILED DESCRIPTION

The present disclosure is drawn to medical trainers, systems, and methods. The exemplary trainers described herein may assist in preparing users for a variety of skills they may use, and challenges they may face, during real procedures on a patient. In this disclosure, a “user” may be any person completing the described action (e.g., surgeon, medical student, technician, nurse, etc.). In addition, the term “distal” refers to a position farther away from a user, and the term “proximal” refers to a position closer to the user.

The disclosed trainers may train users for any procedure that requires navigation of an elongated medical device through a lumen of a patient, and may be particularly useful to prepare users for urological procedures. For example, the trainers may prepare a user to perform procedures involving the kidneys, ureters, bladder, urethra, and male reproductive organs. Reference will now be made in detail to examples of the present disclosure, which are illustrated in the accompanying drawings.

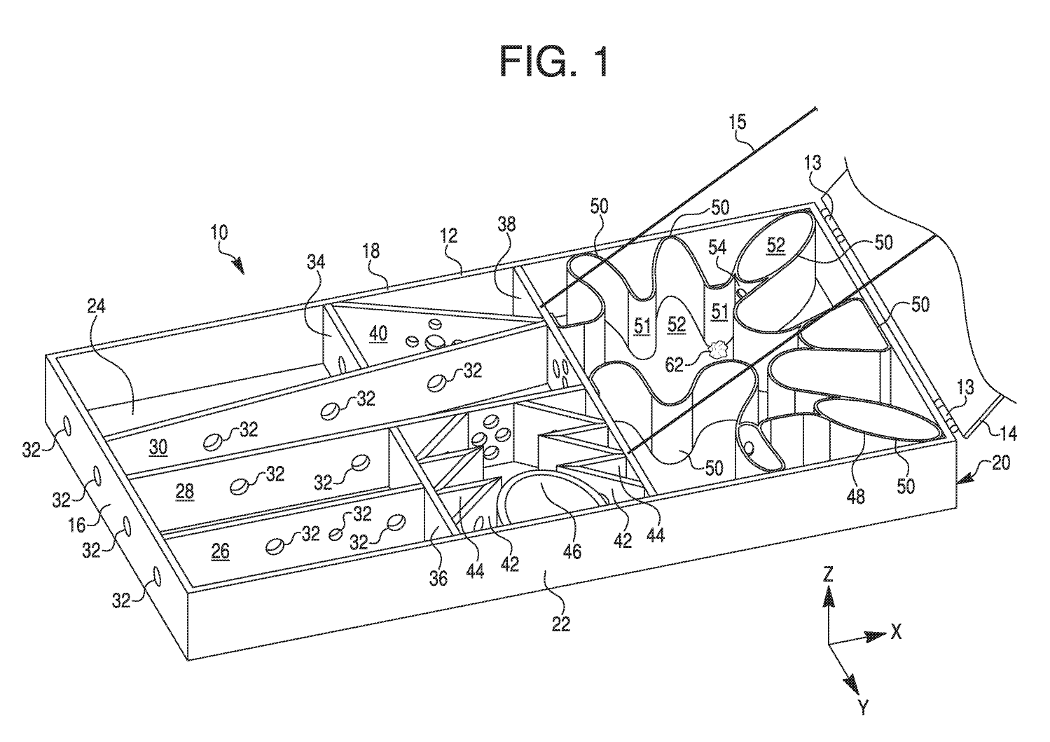

Referring to FIG. 1, a trainer 10 may include a base 12 and a cover 14. The base 12 may include a plurality of outer walls defining an interior space. The outer walls may include front wall 16, first side wall 18, second side wall 22, back wall 20, and bottom wall 24. The base 12 may further include a plurality of inner walls within the space defined by the outer walls. The inner walls may divide the interior space into a plurality of chambers. The outer walls and cover 14 may be straight or curved, although they are shown as straight in FIG. 1. Similarly, the inner walls may be straight or curved. The inner walls may have one or more openings to allow for an elongated medical device to pass through.

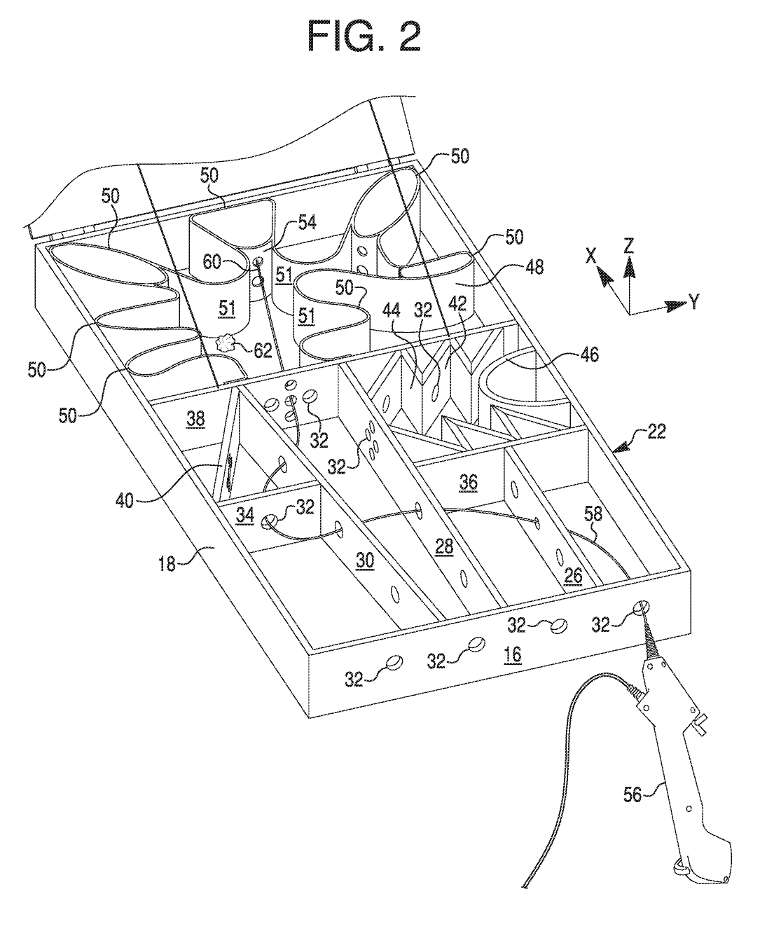

Although only partially shown in the figures, the cover 14 may be rectangular in shape and may have a similar size as the bottom wall 24. The cover may be movable between an open position, as shown in FIGS. 1 and 2, and a closed position. In the closed position, the cover 14 may rest on the top surfaces of the outer and inner walls to enclose the interior space. The cover 14 may be opaque. The cover 14 may be fixed to the base 12 by one or more hinges 13, which may allow the cover 14 to pivot relative to the base. The cover 14 may further be fixed to the base by one or more elongated members 15, such as cables. The elongated members 15 may prevent the cover 14 from opening farther than a predetermined amount. When the cover closes, the elongated members 15 may collapse into an inaccessible chamber of the trainer 10, or may collapse outwardly such that they rest primarily outside of the outer walls when the cover 14 is closed.

The outer walls may form an enclosure that is substantially rectangular. In other examples, the enclosure may be square, oval, circular, pentagonal, or any other geometric or irregular shape. The outer walls may include openings 32. For example, front wall 16 may include four openings 32. Portions of the inner walls may be adjacent to and fixed to the inner surfaces of the outer walls, as shown in FIG. 1.

A first plurality of inner walls 26, 28, 30 may extend generally in an x-direction, from the front wall 16 towards the back wall 20. The inner walls 26, 28, 30 may be rectangular, although they may be any other shape. Each inner wall 26, 28, 30 may have one or more openings 32. For example, inner wall 26 may include three openings 32, inner wall 28 may include six openings 32 (see FIG. 2), and inner wall 30 may include three openings 32. Some of the openings 32 may be arranged along the length of the walls 26, 28, 30 and may be positioned at generally the same height on the z-axis, such as the openings 32 through inner wall 30. Other openings 32, such as the distal-most formation of openings in inner wall 28, may form a diamond shape, with two openings 32 being positioned at the same height on the z-axis, one opening 32 being positioned above those two openings, and one opening 32 being positioned below those two openings. In one example, one or more openings 32 have a different size (e.g., diameter) than other openings 32 on the same wall. For example, the middle opening 32 on inner wall 26 may have a smaller size than the openings 32 on either side of the middle opening, or all three openings 32 may have different sizes.

The inner walls 26, 28, 30 may form a substantially right angle with the front wall 16 (e.g., inner walls 26 and 28) or may extend at a non-right angle from the front wall 16 (e.g., inner wall 30). The inner walls 26, 28, 30 may contact the front wall 16 at locations that are between the openings through the front wall 16. The openings 32 in the inner walls 26, 28, 30 may connect adjacent chambers that are separated by the inner walls 26, 28, 30. In one example, inner walls 28, 30 may have a length that is greater than inner wall 26. Accordingly, the chamber between inner walls 28, 30 may be longer in a proximal-to-distal direction than the chamber between the inner walls 26, 28 or the chamber between the second side wall 22 and the inner wall 26.

Referring to FIG. 2, a second plurality of inner walls 34, 36, 38 may extend generally in a y-direction, from at least one of the first side wall 18 or the second side wall 22 towards the other side wall 18, 22. The inner walls 34, 36, 38 may be rectangular or any other shape, and each inner wall 34, 36, 38 may have one or more openings 32. For example, inner wall 34 may have one opening 32, and inner wall 38 may have five openings 32. In one example, inner wall 36 has no openings, although inner wall 36 may include one or more openings in other examples. The single opening of inner wall 34 may be centered on the wall. The formation of openings 32 of inner wall 38 may include a central opening and four openings surrounding the central opening. In one example, three openings 32 may be positioned at substantially the same height on the z-axis (positioned in a row along the y-axis), a fourth opening 32 may be positioned above the center opening 32 of the three openings, and a fifth opening 32 may be positioned below the center opening 32 of the three openings. One or more of the openings 32 in the formation of inner wall 38 may have a different size than other openings 32 in the formation. For example, the three openings 32 that are positioned along z-axis may have a slightly smaller diameter than the openings 32 to the left and to the right of the three smaller openings 32.

As shown in FIG. 2, the inner walls 34, 36, 38 may form substantially right angles with the first and second side walls 18, 22. In other examples, the inner walls 34, 36, 38 may extend at non-right angles to the side walls 18, 22. Similar to previously-described openings 32, the openings 32 of inner walls 34, 36, 38 may connect adjacent chambers separated by inner walls 34, 36, 38. Inner walls 34, 36 may extend partially across the width of the trainer 10, while inner wall 38 may extend fully across the width of the trainer 10.

The chambers created by the previously-described inner walls may be further divided by additional inner walls. For example, inner wall 40 may further divide the chamber formed by first side wall 18 and inner walls 38, 30, and 34 into two triangular chambers. One of the triangular chambers may be bounded by three walls that each include one or more openings 32. Inner wall 40 may be rectangular or any other shape and may extend diagonally across the chamber in both the x-direction and in the y-direction. Inner wall 40 may include a formation of five openings, similar to the formation of inner wall 38 (see FIG. 1). However, the size of the center opening 32 of inner wall 40 may be larger than the four openings 32 surrounding the center opening 32.

The chamber formed by second side wall 22 and inner walls 36, 28, and 38 may also include additional inner walls. For example, a plurality of straight walls may be arranged in a zig-zag pattern along inner wall 38, and another plurality of straight walls may be arranged in a zig-zag pattern along inner wall 36. Referring to FIG. 2, alternating inner walls 42 of each zig-zag formation may include an opening 32, and in one example, alternating inner walls 44 of each zig-zag formation do not include an opening 32. A curved inner wall 46 may extend from second side wall 22. The curved inner wall 46 may be positioned at least partially between the two zig-zag formations of inner walls 42, 44. The diamond-shaped formation of four openings 32 through inner wall 28 may provide a pathway between the chambers on either side of inner wall 28.

Distal to inner wall 38 is a wall formation 48. The wall formation 48 may be formed of a single, integral wall component or of multiple wall components coupled together. The wall formation 48 may include curved walls that form outward projections 50 and inward projections 51. The outward projections 50 may define interior chambers 52 (see exemplary reference numerals of FIG. 1). The interior chambers 52 may be open to the interior of the wall formation 48 or may be mostly closed by a wall portion 54 having one or more openings 32. In one example, the distal-most protrusions 50 shown in the figures are each closed to the interior of the wall formation 48 by a wall portion 54 having openings 32.

The components (e.g., walls, cover) of the trainer 10 may include any suitable material, such as plastics or metals. For example, the components may include acrylic or polyethylene. In certain examples, the trainer 10 may have a height between 0.5-6 in (0.3-15.2 cm), 1-5 in (2.5-12.7 cm), or about 1.5 in (3.8 cm); a length between 16-36 in (40.6-91.4 cm), 20-32 in (50.8-81.3 cm), 24-28 in (61-71.1 cm), or about 26 inches (66 cm); and a width between 5-15 in (12.7-38.1 cm), 7-13 in (17.8-33 cm), 9-11 in (22.9-28 cm), or about 10.5 in (26.7 cm).

Referring to FIG. 2, a medical device 56 having a flexible elongate member 58 may be used with the trainer 10. The distal end 60 may include a light source and a camera. The medical device 56 may further include an active deflection mechanism for controlling its distal tip. In one example, the medical device 56 may be a ureteroscope, such as the LithoVue™ Single-Use Digital Flexible Ureteroscope sold by Boston Scientific Corp. In one example, the distal end 60 of medical device 56 may actively deflect up to 270°, allowing the user to turn the distal end 60 to make sharp turns with the elongate member 58.

A user may use the trainer 10 to practice controlling the elongate member 58 of the medical device 56. The patterns of walls within the trainer 10 may aid a user in practicing certain skills, such as active and passive deflection and gross and fine torque techniques. Specific exercises may be conducted to aid a user in learning a desired technique. For example, one exercise may include following a pre-selected pathway through certain walls and chambers within the interior space. The pre-selected pathway may be color-coded to identify the pathway for the user. Similarly, exercises may include maneuvers within certain chambers, such as an exercise to inspect the various corners formed by walls 42, 44, and 46.

In one exemplary exercise, as shown in FIG. 2, the user may pass the distal end 60 of the elongate member 58 through an opening 32 in the front wall 16 and through openings 32 in inner walls 26, 28, and 30. Turning the elongate member 58 towards the left may require gross torque techniques. The user may then use an active deflection mechanism of the medical device 56 to turn the distal end 60 and pass it through the opening 32 in inner wall 34. The user may continue to actively deflect the distal end 60 to travel through another opening 32 in inner wall 30. The user may then need to use fine torque skills to pass the distal end 60 through a particular opening in the formation of inner wall 38. Finally, the distal end 60 may travel towards an opening 32 in wall 54.

In another example, the user may pass the distal end 60 through front wall 16 through the second opening 32 from the first side wall 18. The user may then pass through inner wall 28 via the second opening 32 from the front wall 16. The distal end 60 may then deflect off of inner wall 36, between inner walls 28 and 26. Using this passive deflection, the user may pass the distal end 60 through inner wall 26 via the third opening 32 from the front wall 16. This exercise may aid a user in practicing passive deflection skills.

The trainer 10 may provide numerous available challenges for the user to practice maneuvering the elongate member 58. For example, the user may enter the trainer 10 through different openings 32 (e.g., in the front wall 16), may take different pathways across portions of the trainer 10, or may “explore” different regions of the trainer 10 with the distal end 60 of the elongate member 58. Exercises may be conducted with the cover 14 open, to allow the user to directly see the elongate member 58 directly, or with the cover 14 closed, in which the user may rely on the light and camera at the distal end 60 for guidance. In one example, the user may first navigate the elongate member 58 along a selected pathway with the cover 14 open, and then navigate the elongate member 58 along the selected pathway with the cover 14 closed. In contrast to trainer 10, trainers based solely on the anatomy may provide only a single pathway for practice by the user, which may limit the number of challenges and opportunities to practice new skills available to the user. Nevertheless, certain regions of the trainer 10 may resemble anatomical features for training purposes. For example, the formation 48 may resemble renal calyces and may train a user to navigate the pathways within a kidney.

Different exercises may include different challenges to train users from a beginner level to a more advanced level. For example, it may require less skill to pass the elongate member 58 from an opening in wall 30 (see FIG. 2) to the larger opening 32 on the right side of the opening formation in wall 38 than to pass the elongate member 58 through the central opening 32 in the opening formation. This may be because the central opening 32 of the opening formation is smaller than the right side opening, and because a sharper turn is required to pass through the central opening 32 than to pass through the right side opening 32 of the opening formation. Accordingly, a beginner level exercise may direct the user to pass through certain openings 32 of the trainer 10, while an advanced level exercise may direct the user to pass through other openings 32 of the trainer 10. Openings 32 that may require less skill include larger openings or those which do not require as sharp of a turn from the previous opening 32 passed through by the elongate member 58.

In one example, one or more removable objects 62 may be placed within the trainer 10. The objects 62 may simulate stones that have formed in the urinary tract. The user may operate the medical device 56 and accompanying tools (e.g., graspers) to pick up and drop the simulated stones. Similarly, the user may use components associated with laser lithotripsy devices (e.g., an optical fiber) to break apart the simulated stone and remove the pieces from the trainer 10.

While principles of the present disclosure are described herein with reference to illustrative examples for particular applications, it should be understood that the disclosure is not limited thereto. Those having ordinary skill in the art and access to the teachings provided herein will recognize additional modifications, applications, and substitution of equivalents all fall within the scope of the examples described herein. Accordingly, the invention is not to be considered as limited by the foregoing description.

We claim:

1. A trainer for medical procedures, comprising:
outer walls arranged to define an interior space; and
inner walls arranged within the interior space to separate the interior space into a plurality of chambers;
wherein at least some of the inner walls include at least one opening connecting adjacent chambers of the plurality of chambers.

2. The trainer of claim 1, wherein at least some of the inner walls include a plurality of openings.

3. The trainer of claim 1, wherein at least one of the outer walls includes a plurality of openings.

4. The trainer of claim 3, wherein each of the plurality of openings in the outer wall leads to a different chamber of the plurality of chambers, and each of the different chambers is connected to an adjacent different chamber by openings through the inner walls.

5. The trainer of claim 1, wherein at least one of the inner walls is straight and at least one of the inner walls is curved.

6. The trainer of claim 1, wherein the trainer is configured to receive a member of a medical device through an opening in at least one of the outer walls and through openings in the at least some of the inner walls.

7. The trainer of claim 1, wherein a chamber of the plurality of chambers is bounded by only three inner walls, and wherein each of the three inner walls includes at least one opening.

8. A trainer for medical procedures, comprising:
outer walls arranged to define an interior space; and
a plurality of chambers within the interior space and separated from each other by inner walls;
wherein at least some of the inner walls include a plurality of discrete openings; and
wherein at least one inner wall is straight and at least one inner wall is curved.

9. The trainer of claim 8, wherein at least one of the outer walls includes a plurality of openings.

10. The trainer of claim 9, wherein each opening of the at least one outer wall connects an exterior of the trainer to a different chamber of the plurality of chambers, and inner walls separate adjacent chambers of the different chambers.

11. The trainer of claim 8, wherein at least one chamber of the plurality of chambers is bounded by inner walls that include a zig-zag pattern.

12. The trainer of claim 8, wherein at least one inner wall includes a curved wall that forms a plurality of outward protrusions and a plurality of inward protrusions.

13. The trainer of claim 8, further comprising a cover, wherein the cover is movable between and open position and a closed position.

14. A method of using a trainer, comprising:
inserting a distal end of a member of a medical device into an interior space of the trainer, the trainer including outer walls arranged to define the interior space, and inner walls arranged within the interior space to separate the interior space into chambers; and
navigating the distal end through at least some of the chambers, wherein the navigating step includes passing the distal end through openings in at least some of the inner walls.

15. The method of claim 14, wherein the inserting step includes passing the distal end through one of a plurality of openings in one of the outer walls.

16. The method of claim 14, wherein the navigating step includes passing the distal end along a pre-selected pathway within the interior space.

17. The method of claim 14, wherein the navigating step includes active deflection of the distal end and passive deflection of the distal end.

18. The method of claim 14, wherein the navigating step includes passing the distal end through one of a plurality of openings in an inner wall, wherein the plurality of openings are arranged proximate to each other.

19. The method of claim 14, wherein the navigating step includes following a selected pathway with a cover open, and the method further includes repeating the navigating step with the cover closed.

20. The method of claim 14, wherein at least one inner wall having an opening is straight and at least one inner wall having an opening is curved.
